(19) United States
(12) Patent Application Publication
(10) Pub. No.: US 2015/0177939 A1
(43) Pub. Date: Jun. 25, 2015

(54) USER INTERFACE BASED ON WEARABLE DEVICE INTERACTION

(71) Applicants: Glen J. Anderson, Beaverton, OR (US); Giuseppe Beppe Raffa, Portland, OR (US); Ryan Scott Brotman, Beaverton, OR (US); Jamie Sherman, Portland, OR (US); Francisco Javier Fernandez, Portland, OR (US); Philip A. Muse, Folsom, CA (US)

(72) Inventors: Glen J. Anderson, Beaverton, OR (US); Giuseppe Beppe Raffa, Portland, OR (US); Ryan Scott Brotman, Beaverton, OR (US); Jamie Sherman, Portland, OR (US); Francisco Javier Fernandez, Portland, OR (US); Philip A. Muse, Folsom, CA (US)

(21) Appl. No.: 14/368,485

(22) PCT Filed: Dec. 18, 2013
(86) PCT No.: PCT/US2013/076097

§ 371 Date: Jun. 24, 2014

(51) Int. Cl. G06F 3/0484

(52) U.S. Cl. CPC G06F 3/0484

(57) ABSTRACT

Systems and techniques for a user interface based on a wearable device interaction are described herein. A user interaction may be received at a wearable device interface from a user. The user interaction may be identified. A context corresponding to the user interaction may be identified. An action may be initiated based on the user interaction and the context.

### BACKGROUND

Portable electronic devices (e.g., mobile phones, personal digital assistances (PDAs), set-top boxes, etc.) are frequently used for interpersonal communication, such as verbal communication (e.g., a call) or textual communication (e.g., correspondence, a text, email, etc.) from a user of the portable electronic device to other users. Portable electronic devices may also be used in other ways, such as sharing data, listening to music, watching videos (e.g., either stored locally or streamed over a network), or a variety of other applications. Typically, portable electronic devices have small displays and small conventional user input mechanisms (e.g., buttons, keyboard, mouse, trackball, etc.).

Portable electronic devices are generally objects that are held while in use and stored (e.g., in a pocket, on a car seat, etc.) otherwise. In contrast, wearable devices are objects that are designed to be worn on the body and interacted with while being worn. Thus, wearable devices are generally clothing or accessories incorporating electronics (e.g., sensors, processors, storage, etc.).

Example wearable device platforms (e.g., items that may be wearable devices) may include wristwatches, eye glasses, headgear, shoes, shirts, pants, skirts, dresses, undergarments, etc.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of a user interface based on wearable device interaction, according to an embodiment;

FIG. 2 illustrates an example of a system for a user interface based on wearable device interaction , according to an embodiment;

FIG. 3 illustrates a flow chart of an example of a method for user interface based on wearable device interaction, according to an embodiment;

FIG. 4 is a profile of permissions for a user, according to an embodiment;

FIG. 5 is a profile of tracked devices of other users, according to an embodiment;

FIG. 6 illustrates a system for user interface based on wearable device interaction, according to an embodiment; and

FIG. 7 illustrates a block diagram of an example of a machine that may be used to implement various mechanisms and techniques described herein.

### DETAILED DESCRIPTION

Portable electronic devices may include limited traditional user input mechanisms (e.g., small or virtual keyboards, small screens, etc.) that may hamper a user's ability to perform communication tasks, such as identifying a destination address, a social contact (e.g., a friend), etc. However, the portability and often included sensors on a portable electronic device may be used as additional user input mechanisms that may reduce the use of traditional user input mechanisms or mitigate the often poor quality of those mechanisms in portable electronic devices. For example, types of social sharing (e.g., sharing a photograph, providing virtual “high five,” etc.) may be initiated via a “bump” interface (e.g., denoting an activity where it appears that the portable electronic device is physically bumped into the second device). The bump interface may allow mutual authentication and subsequent social sharing between two devices when the two devices have a simultaneous, reciprocal accelerometer event in close proximity. Proximity may be determined via the communication mechanism (e.g., Bluetooth®, infrared light (IR), Near Field Communication (NFC)) or via another mechanism (e.g., satellite navigation, network based location services, etc.).

In an example, a short range wireless network may have limited range, such as between a few inches to several feet. The reduced range provides a spatial proximity context between devices. This spatial proximity context may be used to determine user intent without specifically prompting the user. For example, some NFC based communications may automatically (e.g., without user intervention) establish a communication channel as soon as two electronic devices may communicate. Because NFC typically limits the range on the communication (e.g., 4 inches or less), the ability to communicate permits the determination that the devices are placed close to each other. The proximity context allows an assumption that the user has physical access to the second device and that the user intended to communicate with the second device.

Some portable electronic devices may include a touch-screen input mechanism. In an example, images may be flicked, swiped, thrown, etc. from one display to another. That is the portable electronic device may simulate an image's motion given a touch input of velocity and direction. The portable electronic device may identify the second electronic device as a device physically located in a path that the image would have followed through space were that image actually traveling through space. The portable electronic device may contact the second device based on this identification and transmit the image. Thus, the relatively simple physical act of flicking the image towards the second device initiates the transfer of the image.

Portable electronic devices, such as those discussed above, are generally objects that are held while in use and stored (e.g., in a pocket, on a car seat, etc.) otherwise. In contrast, wearable devices are objects that are designed to be worn on the body and interacted with while being worn. Examples may include clothing or accessories incorporating electronics (e.g., sensors, processors, storage, etc.). For example, a shirt with embedded and addressable light elements is a wearable device. Further a wristwatch sized video screen and audio input-output device on a bracelet is a wearable device. It is understood that although a device may be affixed to a body, for example by affixing a tube monitor and power supply to a harness, such devices are not wearable devices because they are not clothing or accessories with incorporated electronics. Wearable devices may include user input mechanisms, output mechanisms directed to different human senses (e.g., visual, audio, haptic, olfactory, etc.), sensors (e.g., for humidity, user heart rate, ambient sound, barometric pressure, etc.), data storage, power, etc. In an example, a single user may wear more than one wearable device at a time.

Because wearable device may be small, have low power requirements, or otherwise compromise performance in order to be wearable, wearable devices may collaborate with nearby processors to perform certain tasks. For example, a shirt may include a display indicating the compass direction it faces. The display may communicate with the user's portable electronic device (e.g., smart phone) to provide the direction (e.g., using a compass of the smart phone).

The wearable devices alone, or in combination with portable electronic devices, may provide additional interaction context information between users. Such context information may include touching a particular area on the body, proximity, location, orientation (e.g., what compass direction something is facing, whether it is upside-down, etc.), environmental factors, identity, etc.

A proximity context may include a spatial proximity context. The spatial proximity context may include indications of entities within a predetermined distance from the user. In an example, a proximity event includes a modification to the spatial proximity context. Such a modification may include the addition of a new entity (e.g., the new device moved within the predetermined distance) or the removal of an old entity (e.g., the old device moved beyond the predetermined distance). In an example, a proximity event includes a temporal proximity context. A temporal proximity context includes a time window relative to an indication of an interaction. For example, if a touch interaction is indicated (e.g., by a wearable touch sensor) the temporal proximity context may is an event occurring within the predetermine distance. For example, a registered touch on wearable device pants may include a proximity context of plus-or-minus a second of the time of the touch. In an example, a proximity event is a user interaction with a wearable device interface within a proximity context.

This additional context information may facilitate additional interaction scenarios not available using portable electronic devices alone. For example, a ring wearable device of a first user may be touched on a shirt wearable device of a second user. The ring may transmit the identity of the first user and a message when touching the shirt. The shirt may interface with the ring upon the touch and receive the message. The shirt may then display the message in response to determining that the first user is authorized to place a message on the shirt. The shirt may also display the message in an area around which the ring touched the shirt. Thus, the simple act of touching the second user's shirt allows the display of a message at that location without any further intervention by either user.

In general, context information, or simply context, as used herein, is information that characterizes a situation of an entity (e.g., a person, place, or object) relevant to an interaction (e.g., between users, a user and an object, a user and an application, etc.). In an example, context is information not directly supplied by the user as part of the interaction. Thus, when communicating between devices, the user entering the address of the destination device is not context. However, context may include user input not directly related to the interaction. For example, a user texting his spouse that he is sad may be used to determine an emotional state of the user (e.g., sadness) in an interaction (e.g., update a virtual “mood ring” on friend's devices within a room). In an example, the context includes user information, such as a profile, identification, interests, etc. In an example, context may include, but is not limited to, information the user is attending to (e.g., reading work related email), an emotional state of the user, the user's focus of attention (e.g., a child playing a sport), location and orientation data (e.g., facing north, while upside down, at home), date and time of day, state of objects (e.g., what is nearby, how many of them are there, etc.), and awareness of people in the user's environment (e.g., who is in the room with the user, who is in the hotel, etc.).

The context may be used to augment (e.g., adapt, enhance, etc.) interactions between the user and others. For example, a charm bracelet may chime when a friend comes within ten feet of the user. However, the context may indicate that the user is in a place where such noise would be disruptive, such as a place of worship, or a room in which several people are present but no one is speaking above a whisper. In this example, the context may be used to mute the charm. In an example, context may be used to provide task-relevant information and/or services to a user, such as presenting information or services to the user, automatic execution of a service, tagging of context to information for later retrieval, etc. In an example, the context is acquired automatically. In an example the context acquisition is continual or continuous. In an example, the context is derived from a sensor in a wearable device.

Interactions, such as sharing, may benefit from wearable device based context. For example, sensor events across devices may be used to indicate an intention of one user to share an item with a second user. For example, the first user has a shirt with a display that is displaying an image. The first user may tap the image on her shirt. Such a tap may identify the image to the first user's connected phone. The first user may then tap a second user's shirt. This second tap may indicate the first user's desire to transfer the image to the second user. The second user's shirt, registering the tap at the same time as the first user's tap (e.g., as measure by a wearable device glove of the first user) broadcasts that it is to receive an image from a user who tapped at a given time. The given time may be correlated to the first user's tap time and thus the first user's phone may identify the second user's shirt. The first user's phone may then transfer the image to the second user's shirt. Upon receiving the image, the second user's shirt may display the image at the location that the shirt registered the tap.

Other interaction examples may include context information previously entered by the user. For example, taking the shirt tapping example, discussed above, the second user may have specified a content filter for his shirt. Thus, if the image is inappropriate (e.g., an image of a scantily clad person and a filter of “child friendly”), the second user's shirt may not display the image, may refuse to accept the image, etc.

Using a wearable device to derive context, and using that context to improve user interactions overcomes some limitations of portable electronic device, or non-portable electronic devices (e.g., a desktop computer). For example, a phone will generally be unable to determine if something stepped on a user's foot, whereas a wearable device shoe will be able to make that determination. The context thus expands the interface capabilities of the user (and her devices) without imposing additional burdens on the user.

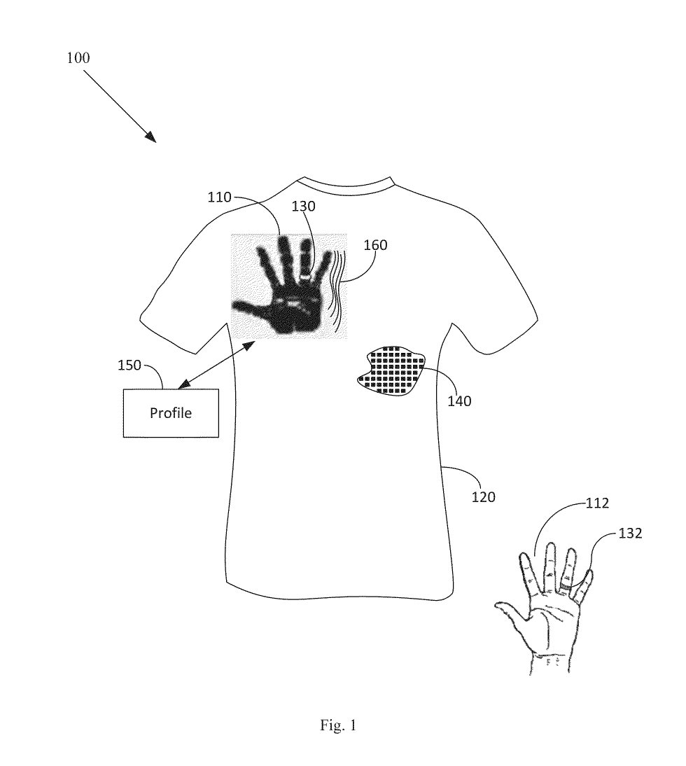

FIG. 1 presents a shirt-based display 100, according to an embodiment. In FIG. 1 as illustrated, the shirt based display 100 shows a handprint 110 on a shirt 120 representing the result of a touch (e.g., user interaction) from a friend. The handprint 110 shows an image of a ring 130 from the hand 112 of the friend who is wearing a ring 132. The ring 132 may be detectable by capacitive sensors 140 (e.g., wearable device interface) on the shirt 120. The ring 132 may be associated with a profile 150 (e.g., part of a context) that allows contact from the friend to leave content on a specified display (e.g., the shirt 120) by touching the display. The same friend may subsequently cause haptic output 160 (e.g., in an area defined by the handprint 110) on the shirt-based display 100 to create a representation of the pat on the back as a kind of “echo” of a previous encounter. As noted above, the wearable device user's phone may facilitate the interaction, such as acting as intermediaries in detection and content sharing.

As illustrated in FIG. 1, the touch is a type of spatial proximity event because the hand 112, or the ring 132, entered a predefined distance (e.g., zero distance) during the touch, which is the user interaction. An additional example proximity event, in this scenario, is the detection of the ring immediately prior to the touch. For example, if the defined spatial proximity for the interaction is less than five inches, the shirt 120 may display an alternative image, such as a target, in order to convey where the handprint 110 will be centered if a touch occurs. In this scenario, the movement of the ring 132 into the proximity of the shirt 120 is the user interaction and also represents a (spatial) proximity event. The context may include the orientation of the ring 132 with respect to the shirt 120 as well as an identification of the user to the wearable device system. This context information may be used to identify the user and discern the user's intent to place the handprint 110 on the shirt 120. Thus, for example, by considering the palm side of the ring 132 a user interaction, and ignoring the back-hand side of the ring 132, the user's intent to place a handprint 110 on the shirt may be determined

In an example, temporal proximity may also be used to determine user intent. For example, the user may have designated a picture to share but not designated a recipient. The touching of the shirt 120 within a window of designating the picture sharing is a temporal proximity event. The wearable device system may be aware of a broadcast indicating that a picture will be shared and register the touch within the temporal proximity of the broadcast. Thus, in an example, the wearable device system may respond to the broadcast that it should receive the picture. Alternatively, the ring 132 may register the touch within the temporal proximity and garner an identification of the wearable device user from the shirt 120. In either scenario, the user's intent to transfer the picture to the wearable device user may be determined from the temporally proximate user interaction with the shirt 120.

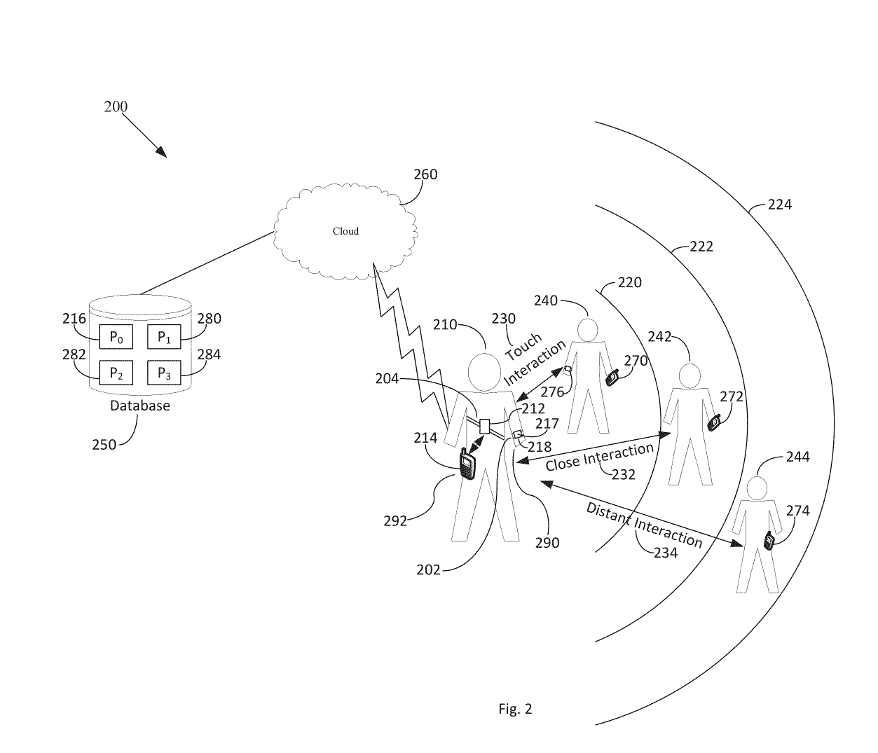

FIG. 2 illustrates a system environment diagram 200, according to an embodiment. In FIG. 2, a wearable device user 210 is using a wearable device 212 and a mobile device 214. Within a first region 220 (e.g., first spatial proximity), touch interaction 230 (e.g., user interaction) with a first person 240 (e.g., first user) may occur. Within a second larger region 222 (e.g., second spatial proximity), close interaction 232 (e.g., turning or stepping toward the wearable device user) with a second person 242 (e.g., second user) may occur. Beyond the second region, within a third region 224 (e.g., third spatial proximity), distant interaction 234 (e.g., waving or pointing at the wearable device user) may occur with a third person 244 (e.g., third user). While FIG. 2 shows three regions, 220, 222, 224, those skilled in the art will recognize that embodiments may include a different number of regions, less than or greater than the number of regions shown in FIG. 2. Furthermore, those skilled in the art will recognize that while three people other than the wearable device user 210 are shown, the representation of people within the three regions 220, 222, 224 may actually be the same person merely shown at different distances from the wearable device user 210.

In FIG. 2, the wearable device user 210 may set (e.g., in the context) a permission level for the first person 240 to enable the first person 240 to be able to have sharing privileges with at least one of the output devices 212, 214 of the wearable device user 210. The sharing privileges may be provided when the first person 240 is in the same location as or remotely proximate to the wearable device user 210. Remotely proximate refers to a spatial proximity that has both an outer bound and an inner bound. For example, the outer bound may be ten feet and the inner bound may be one foot. Thus, a remotely proximate context based on these bounds will not include user interactions closer than one foot and beyond ten feet. Accordingly, the wearable device user 210 may flexibly set regions for accessibility, e.g., first region 220, second region 222, third region 224, etc.

Example output devices may include visual (e.g., a display on the mobile device 214 of the wearable device user 210, lights, texture changes, etc.), haptic devices (e.g., a vibration from the wearable device 212, mobile device 214, interactive clothing, etc.), sound devices (e.g., from the wearable device 212, the mobile device 214, etc.), olfactory devices (e.g., from digital scent technology) and other types of devices. In an example, a combination of output devices may be used

In an example, the wearable device user 210 may set device permission levels (e.g., in the context) that define how output device, e.g., wearable device 212, mobile device 214, interacts with other devices (e.g., just proximity of another person vs. touch, etc.). The device permission level may also prescribe interaction based on a part of the body on which an output device is placed.

A wearable device user 210 may set different priorities (e.g., in the context) for users. For example, the second person 242 (e.g., a spouse) may be given a higher priority than the first person 240 (e.g., a casual acquaintance). In this example, a conflict between the two users (e.g., in either interaction or output) may be resolved in favor of the higher priority user. Thus, even though wearable device user 210 may be interacting with the first person 240, the detection of presence of the second person 242 overrides interaction with the first person 240. Accordingly, different policies of priorities among users may be used.

In an example, the action may be modified, or selected from a plurality of actions, based on the context. In an example, the context includes data representing a situation or venue in which the wearable device user 210 may be found. The situation may be informed by the other persons 240, 242, 244, as, for example, determined by the ensemble of sensors worn by wearable device user 210. Venue and situation may be combined in order to make the determination. For example, a place of worship may be a venue in which, for example, distracting displays of sound are acceptable at some times (e.g., during a raucous song) and not at others (e.g., during directed prayer). The ensemble of sensors worn by wearable device user 210 may be used to discern between these two conditions based, for example, ambient noise, or partner context data from the other persons 240, 242, 244. In contrast, an outdoor venue may have no restrictions upon distracting noise and thus the situational element is not relevant to the action.

In another example, in some social contexts (e.g., in a house of worship, at a wake, in a movie theater, etc.) the wearable device user 210 may not want a bracelet to glow—e.g., as an output action for a spatial proximate event of entering an area near the wearable device user 210—for anyone that is detected by the sensors. In other situations or venues, the glowing bracelet may be acceptable, e.g., a restaurant, home, etc. Context may also include information about an activity, either presently, previously, or prospectively, engaged in by the wearable device user 210, such as, running, biking, etc. Such activities may be considered a situation (e.g., situational context) for the wearable device user 210.

The context may also include profile data of the wearable device user 210 that may be used to in the action (e.g., to modify the action or to select the action from a plurality of actions). As noted above, additional context data that may be used include emotional condition, concentration level, stress level or openness of the wearable device user 210 to determine what interactions are allowed. As used herein, openness is a value on a spectrum from closed to open and indicative of the wearable device user's willingness to try new things (e.g., adventurousness, caution, paranoia, extraversion/introversion, etc.) Emotional condition, concentration level, stress level, and openness may be determined from direct input (e.g., the wearable device user 210 changes a status from happy to sad) or indirect input (e.g., the wearable device user has been listening to sad music). In an example, the respective determinations may be made from an analysis of the wearable device user's actions, information sent (e.g., in an email), location (e.g., in a car (for concentration), at work, at an amusement park), time (e.g., during a test, during a sleep period, etc.), or by observing physiological factors (e.g., facial expressions, galvanic skin response, heart beat monitoring, etc.).

A device without its own cloud connectivity may work through a second device to have access to a database 250 in the cloud 260. For example, the wearable device 212 may access the cloud 260 through the mobile device 214. By accessing the cloud 260, the system may allow the wearable device user 210 to provide sharing privileges with output devices 270, 272, 274 of others 240, 242, 244 when in the same location (e.g., spatial proximity context of, for example, a building, room, etc.). Once another device, e.g., one of devices 270, 272, 274, is determined as being in the vicinity of the wearable device user 210, sensor data about observable activities may be shared with the wearable device user 210 and others in the vicinity. As used herein, observable activities are those movements or emissions that may be observed. Thus, moving in space, re-orienting, emitting light, emitting sound, emitting chemicals (e.g., odor), are all observable activities. Observable activity monitoring and sharing permits the devices 212, 214 of the user 210, for example, to learn certain things about others 240, 242, 244, such as whether they are being worn by a person on the move as opposed to being stationary in the environment. In an example, the database 250 is local to the mobile device 214 as opposed to being in the cloud 260. In an example, the database 250 is a part of the wearable device as opposed to being in the cloud 260.

The wearable device user 210 may share with others 240, 242, 244 information (e.g., the context) so that correlative analysis may be done. For example, a partner context may be retrieved and compared with the context in order to inform the action. For example, a pair of heterosexual people, one man and one woman, are interested in dating people with similar interests. As they pass each other in a bar, a spatial proximity (e.g., close) event is detected. Each may exchange contexts and each may analyze the respective partner context against their own to determine capability. If compatibility is determined, then an output on each may be imitated indicating the compatibility to the respective person, or to each other (e.g., a pulsing heart appears on each's shirt). In an example, the context may include information about where the wearable device user 210 has been recently, media experiences (e.g., books, music, movies, etc.), preferences (e.g., restaurants, food, color, clothier, etc.). In an example, the systems may correlate a profile 216 (e.g., in the context) of the wearable device user 210 with profiles 280, 282, 284 (e.g., in respective partner contexts) of the others 240, 242, 244 to show items of interest to friend-to-friend (F2F) parties to show items of common interest.

Identification of a trusted device, mobile device 214, via a wireless cloud 260 may allow lower authentications using touch input. For example, if a trusted device, such as device 272, is detected nearby relative to wearable device user 210 and mobile device 214, the threshold for a trusted match of a capacitive input may be lower than if the device is remote, such as device 274.

Different sharing results may be prescribed depending on how a device, e.g., wearable device 212, mobile device 214 or wearable device user 210, interacts with each device 270, 272, 274 or others 240, 242, 244. For example, if the wearable device user 210 triple taps a finger on a visual display of device 270 of the first person 240, it may mean the first person 240 wants to display the same design on the display as the wearable device user 210. Interaction by a remote user, e.g., third person 244, may also include feeling haptic or sensing other output from a face to face interaction among co-located people, e.g., wearable device user 210 and the first person meet face to face.

Accordingly, embodiments described herein include collecting a variety of sensor information and other contextual information and storing it in a context. The collection may precede or be concurrent with the user interaction (e.g., touch) to another device, and thereby altering the command in some way.

Also, the part of the body on which the device is worn, e.g., the wrist 202 or torso 204, may further alter the content or execution of the command. For example, if wearable device user 210 makes a specific, pre-defined touch gesture on a wearable device 212 worn on the torso 204 of the wearable device user 210 to select a piece of content and then touches the wearable device 212 to device 272 of the first person 240, certain content from wearable device 212 may then be displayed on device 272 of the first person 240. The content displayed on device 272 of the first person 240 may be determined based on the wearable device 212 being worn on of the wearable device user 210.

These systems may also track people with a high degree of accuracy.

The movement of people, especially relative to each other, may be used as a factor in the context. For example, if the wearable device user 210 is closer to the first person 240 than the second person 242, but currently moving away from the first person 240 and toward the second person 242, the system may use this context information to weigh the probability of the wearable device user 210 engaging with the second person 242 as higher than the probability of the wearable device user 210 engaging with the first person 240. The system may weigh other probabilities other than the location of users.

The combination of orientation and a gesture may result in a different meaning than the orientation or gesture alone. Touch gestures on the wearable display may take different meaning, i.e., control function, depending on the orientation in three-dimensional (3D) space. For example: consider wearable control of music play. With the wrist held out in front so the screen 217 of the wrist-worn device 218 is on a horizontal plane a swipe up on the screen 217 might change the fade control back-to-front or vice versa, whereas when the screen 217 of the wrist-worn device 218 is held on a vertical plane, the same up swipe on the screen 217 raises (or conversely lower) the volume. Touch gestures on the first side 290 of a part of the body may “go through” the person to the second side 292 of the body to control a display space of the mobile device 214 on the second side 292 of the body.

Touch/bump with multiple wrist-worn devices 218, 276 may be arranged to leverage characteristics of curved displays. Touching/bumping two wrist-worn devices 218, 276 may capture the touch point on wrist-worn devices 218, 276. In this way, in addition to a wireless link being established, a touch point/area may be assigned to the wrist-worn devices 218, 276. In this way, one device 218 may establish different connections with more than device 276. The iconic representation from the initial touch event may remain on the user interface of wrist-worn device 218 by simply touching the device in different parts of the surface/touch screen 217. When content is sent from one device 218 to another device 276, the content may disappear/appear on the sending/receiving device 218 from the point/area of contact thereon. In addition, when the wrist-worn device 218 stays “attached” in the contact point, graphic effects/animations may be applied to the content being transferred, e.g., an image on the display 217, to show the transition from wrist-worn device 218 to device 276 in the contact point. The touch points may move on the display 217 of the wrist-worn device 218 depending on where they are relative to the device's owner, e.g., to the left, to the right, close or far, etc.

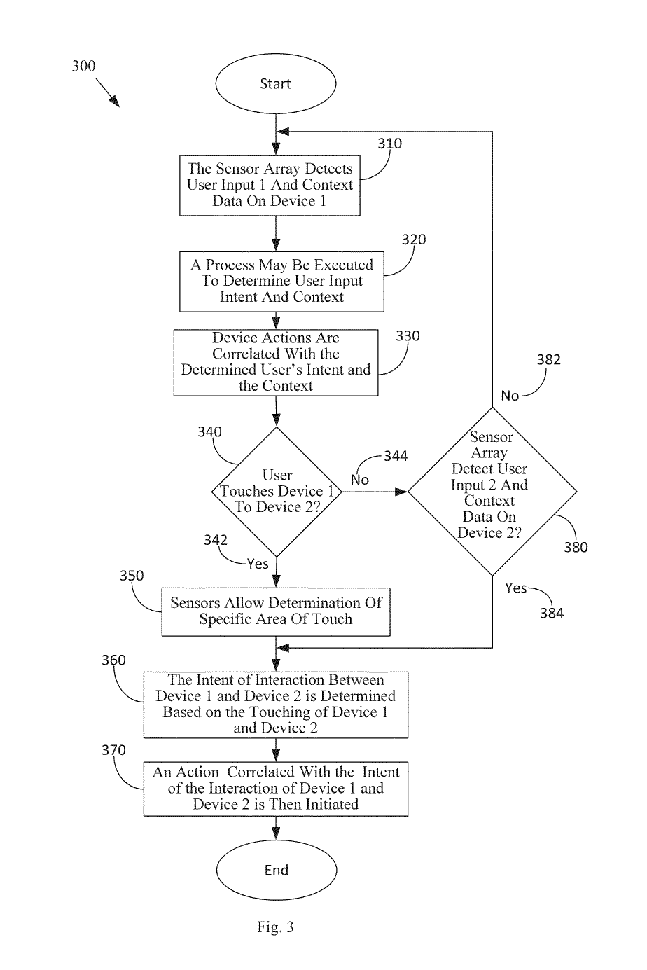

FIG. 3 illustrates a flow chart 300 of a method for determining a user's intent for an interaction, according to an embodiment. Intent, as used herein, refers a determination of whether an activity registered by a sensor is accidental or intentional by the user and also what user interaction from several options was intended. For example, as noted earlier with respect to FIG. 1, a ring worn by the user may touch the shirt and be noted as an activity that could be a user interaction. If the ring brushes the shirt because the user is traveling through a crowd, it may not be the intention of the user to interact with the shirt. Conversely, if the ring touches the shirt in the user's act of placing a hand on the wearable device user's shoulder, such contact is likely a user interaction. The specific circumstances may be discerned via the context. For example, if the context includes information that the palm-side of the ring made contact with the shirt, the user's intent to interaction (i.e., a user interaction) may be determined.

The following may be used to determine the user's intent. At block 310, the sensor array may detect User Input 1 and the context on Device 1. At block 320, a process may be executed to determine a user's intent for a user interaction provided to Device 1 and the context. Device actions may be correlated to the determined user's intent and the context (block 330). For example, a determination of whether the user touches Device 1 to Device 2 is made (block 340). If yes 342, sensors allow determination of a specific area of touch (block 350). The intent of interaction between Device 1 and Device 2 is determined based on the touching of Device 1 and Device 2 (block 360). An action correlated with the intent of the interaction of Device 1 and Device 2 is then initiated at block 370. An action may be correlated with the interaction based on the context corresponding to the touching of Device 1 and Device 2. The context may include data provided by sensors and/or rules associated with such action. If the user does not touch Device 1 to Device 2 (transition 344), a determination is made whether the sensor array detects user interaction 2 and context data on device 2 (decision block 380). If no 382, the process returns to the beginning 380. If yes 384, the process flows to where the process determines the intent of interaction between Device 1 and Device 2 is determined based on the touching of Device 1 and Device 2 360 and the action correlated with the intent of the interaction of Device 1 and Device 2 is then initiated 370.

In an example, a device (e.g., Device 2) is configured to operate through a person in order to effectuate the user interaction. For example, a device (e.g., Device 2) may send an electrical signal using flesh (e.g., a hand) as a conductor. For example, a wrist-based device may conduct electrical impulses onto a user's skin, and the pulse pattern (frequency and/or amplitude) may be particular to that individual. Thus when that user touches a device with a finger, the touch device may be able to sense the identity of that individual. Thus, in an embodiment, the user may be able to substitute a touch of the skin for a touch of the actual device in a user interaction.

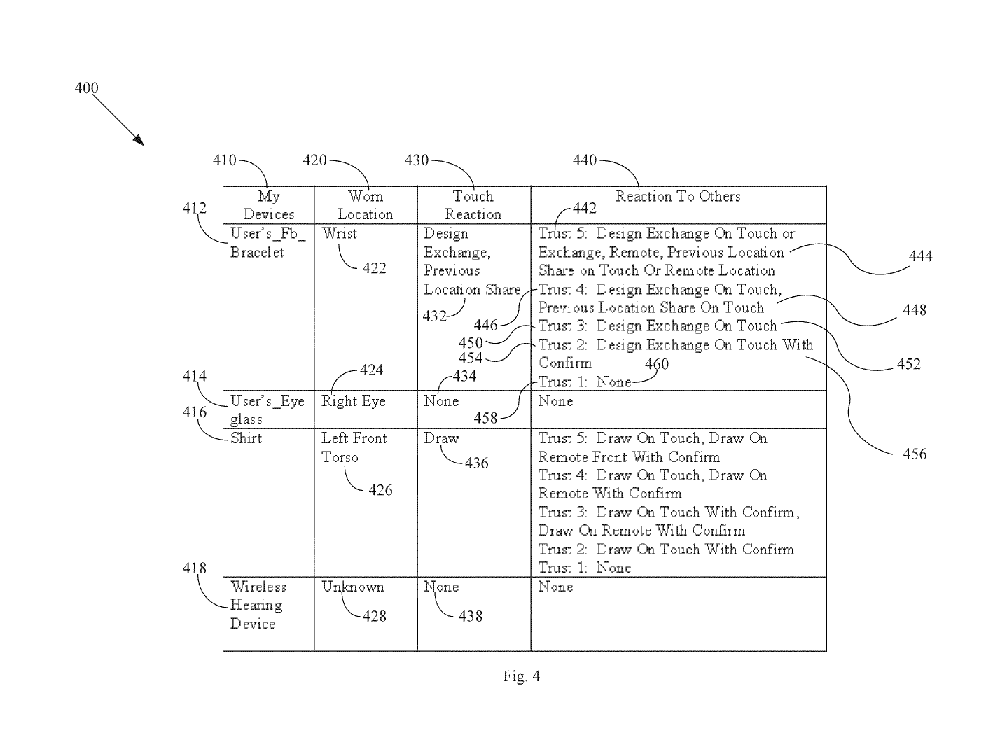

FIG. 4 is a profile 400 of permissions for a user, according to an embodiment. As noted above, the profile 400 is a part of the context. FIG. 4 shows an example of data (e.g., content contents, database, etc.) of permissions based on trust level of other devices. In FIG. 4, the trust ranges from 1 to 5, with 5 being the most trusted. FIG. 4 illustrates values for my devices 410, the location worn 420, the touch reaction 430 and the reaction to others 440. Under my devices 410 is a user's friendship bracelet 412, a user's eyeglass 414, a user's shirt 416, and a wireless device 418. Under worn location 420 is the wrist 422, the right eye 424, the left front torso 426, and unknown 428. Under touch reaction 430 is design exchange, previous location share 432, none 434, draw 436, and none 438.

Under reaction to others 440, the profile 400 indicates that another device with trust level 5 442 is able to exchange display designs or configurations on a user's bracelet by touching it or by accessing it remotely and allow another device to elicit the locations that the traveled to recently, again either through touching or accessing remotely 444. A device with a trust level of 4 446 may perform the same functions when touching, but may not be allowed to exchange designs or location information with a user remotely 448. A trust level of 3 450 may allow the exchange of a design with a touch 452. For example, the user may prescribe that interactions with an eyeglass display 414 or a wireless device 418 are not allowed. The shirt 416 allows drawing on its display 436 depending on trust level. A trust level of 2 454 may allow the exchange of a design with a touch, but a confirmation is also provided 456. A trust level of 1 458 does not allow interactions 460.

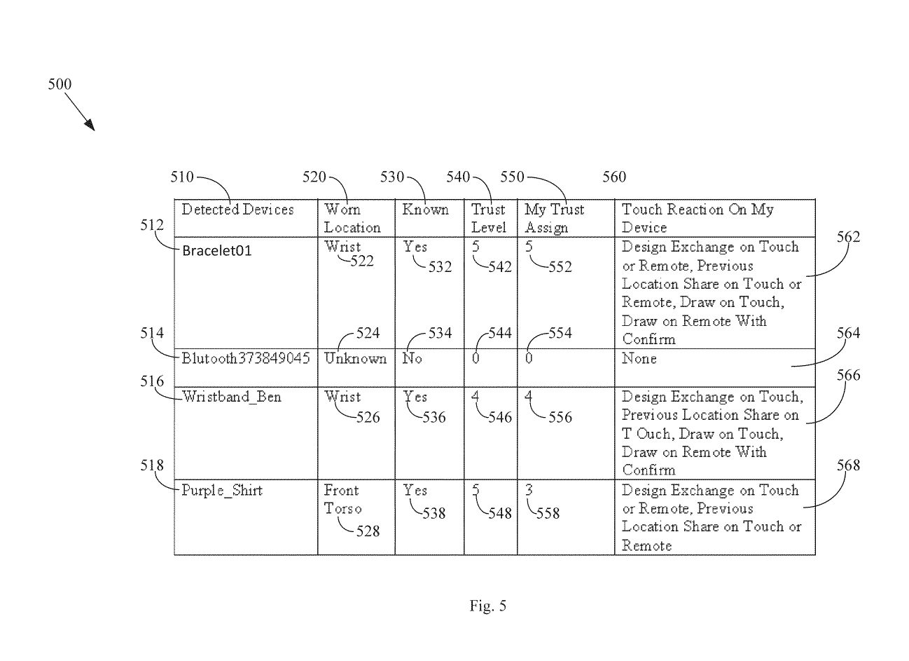

FIG. 5 is a profile 500 of tracked devices of other users according to an embodiment. As noted above, the profile 500 is a part of the context. FIG. 5 shows information for detected devices 510, worn location 520, whether the device is known 530, the trust level of the device 540, the user's trust assignment 550, and the touch reaction on the user's device 560. Under detected devices are a bracelet 512, a Bluetooth device 514, a wristband 516, and a purple shirt 518. Under the worn location 520, examples may include the wrist 522, unknown 524, wrist 526, and front torso 528. Under known 530 is yes 532 for the bracelet 512, no 534 for the Bluetooth device 514, yes 536 for the wristband 516, and yes 538 for the purple shirt 518. Under the trust level 540 is the 5 542 for the bracelet 512, 0 544 for the Bluetooth device 514, 4 546 for the wristband 516, and 5 548 for the purple shirt 518. Under the user's trust level 550 is 5 552 for the bracelet 512, 0 554 for the Bluetooth device 514, 4 556 for the wristband 516, and 3 558 for the purple shirt 518.

Accordingly, the bracelet 512 of another user has a high trust value 542 and the accompanying permissions 562. An unknown Bluetooth device 514 is associated with little or no trust 544 and correspondingly, no permissions 564. The wristband 516 belongs to a friend with a slightly lower level of trust 546 than the bracelet 512, with corresponding touch reaction 566. The purple shirt 518 is worn by another user and has a high level of trust 548 and corresponding permissions 568.

Note that the database structure of the profiles may take many forms and include more profiles or factors. For example, trust level may interact with display location on the body, there may be a table of rules for which devices have which update capabilities when touching, and there may be fields that include contextual factors such as location, which may vary display behavior. Factors in the environment and how the display is worn may influence how sharing occurs, beyond just a sensor event and location. For example, the location on the body of an output device like a display, speaker, or haptic may influence how sharing occurs.

In contrast, a simple touch/bump process does not evaluate any contextual factors to determine sharing in an automated way. Simple touch/bump works on the primary phones and PCs, but there are no secondary levels of sensing and connectivity. Moreover, simple touch/bump only uses an accelerometer to detect an interaction.

Embodiments may use an accelerometer like simple touch/bump devices, but other sensors are also used to provide additional capabilities including additional sensing and/or connectivity to the cloud. Thus, many other factors besides an accelerometer event in near proximity may be used to trigger sharing and/or different levels of sharing. In addition, the use of capacitive detection of touch is not included in simple touch/bump technologies.

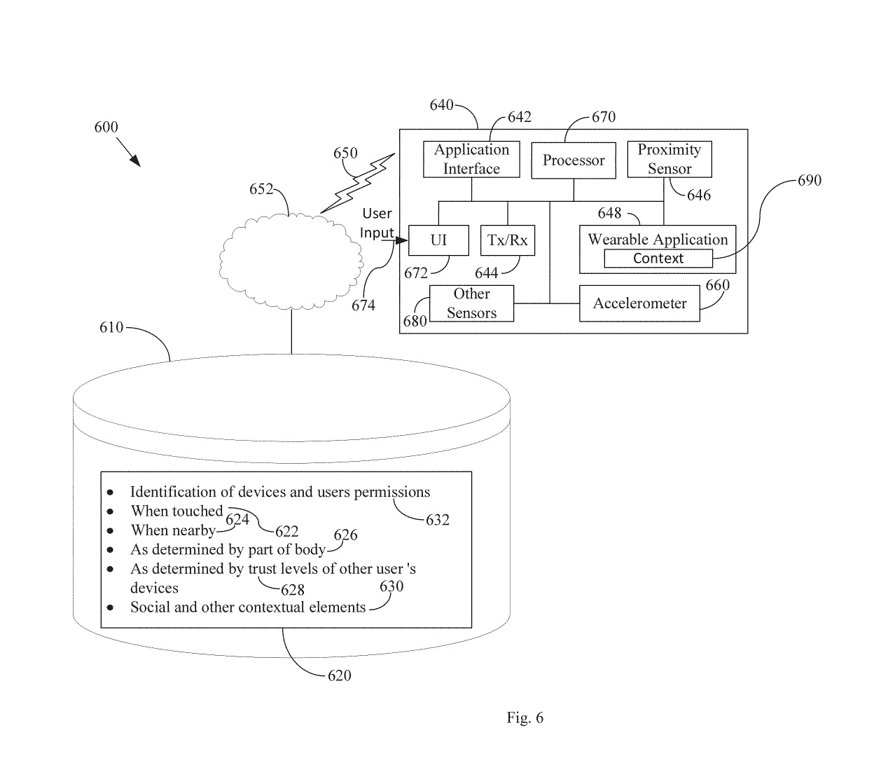

FIG. 6 illustrates a system 600 for supporting a wearable device according to an embodiment. A database 610 of near-vicinity device characteristics is arranged to store detailed information 620 about how devices interact. For example, the characteristics provided by the information 620 may include factors, such as when touched 622, when nearby 624, as determined by part of body 626, as determined by trust levels of other user's devices 628, and social and other contextual elements 630. Social and personal context 630 may be provided to the database 610 and updated in real time. The database 610 may also include identification of devices and users permissions 632.

A device 640 may provide an application interface 642 to allow a user to update the database of near-vicinity device characteristics 620. A wearable application runs on worn devices and is able to capture proximal users. Upon a shared interaction, e.g., mutual touch on shirt, shake hand, bump, etc., a link 650 may be created between the two users through the cloud 652 to the database 610. Each of the users may then use the application interface 642 to edit details related to the specifics of the interactions allowed as well as context and other constraints. The editing of the database 610 may be performed online or offline. A transceiver 644 provides the communication to the cloud 652 and other devices (not shown in FIG. 6). The device may perform proximity/localization (if centralized) using a proximity sensor 646.

The interactions are supported by an application 648 executed by a processor 670 on the device 640 as well as providing security of transmission and privacy of data, and provisioning to authorized users keys and other mechanisms may be used to interact with another person's device. Further, as mentioned above, the device may also include an accelerometer 660. The device includes a user interface 672 that is arranged to receive user input 674. The user interface 672 may incorporate any number of input mechanisms, such as keyboards, pointing devices, touch sensitive surfaces, microphones, cameras, etc.

The processor 670 is arranged to identify the user input 674. From rules, such as information 620 and information, which may be derived from information provided by proximity sensor 646, accelerometer 660, and other sensors 680, context 690 may be derived by processor 670 for use by the wearable application 648.

Then, the processor 670 may initiate an action correlated with the identified user input 674 and the context 690, which may be associated with the user input 674. Context 690, as used herein, refers to any information that allows a user or device to characterize a situation of an entity, such as a person, place, or object, relevant to the interaction between a user and an application. The use of context 690 in this manner may be referred to as context-aware computing. However, context 690 is useful information other than user input. For example, context 690 may be used to provide task-relevant information and/or services to a user including the presentation of information and services to a user, automatic execution of a service, tagging of context 690 to information for later retrieval, etc. By gathering context 690 information, a processor 670 may adapt its actions according to its location of use, the collection of nearby people and objects, as well as changes to those objects over time. Context 690 may include, but is not limited to, information the user is attending to, an emotional state of the user, the user's focus of attention, location and orientation data, date and time of day, state of objects and awareness of people in the user's environment. Moreover, context 690 is typically gathered in an automated fashion that uses a combination of sensing and complex rules to allow applications to react to relevant changes in a state of an entity.

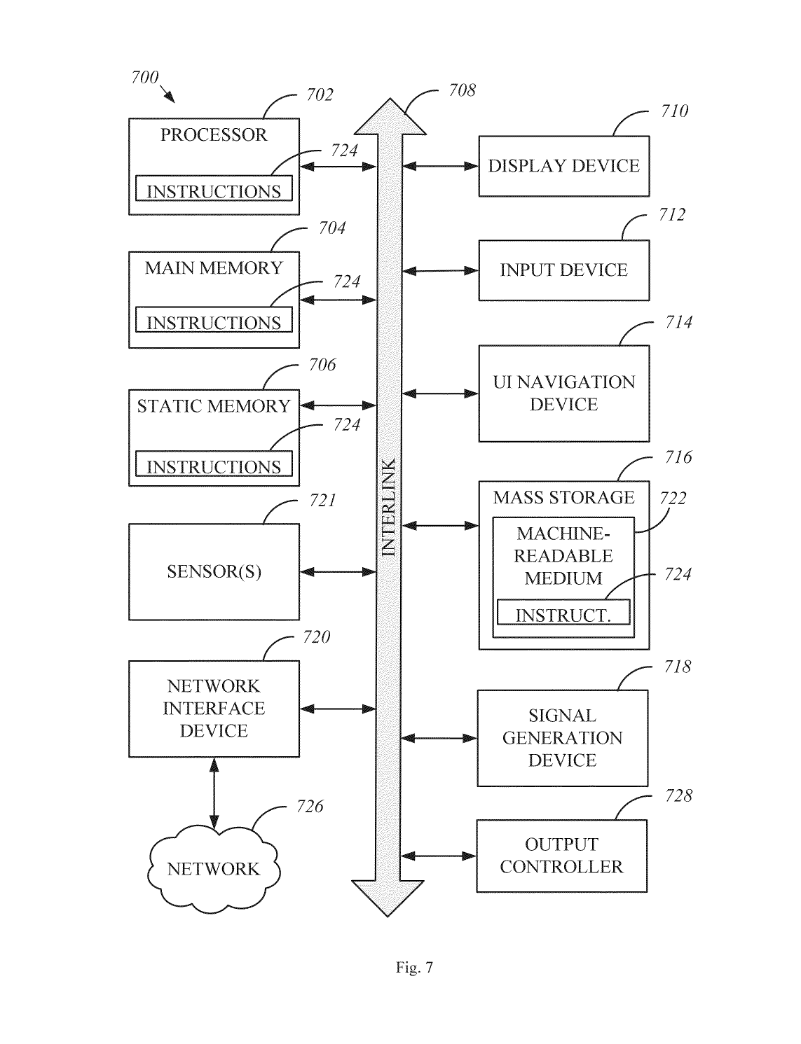

FIG. 7 illustrates a block diagram of an example machine 700 for providing actions on wireless devices based on context according to an embodiment upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine and/or a client machine in server-client network environments. In an example, the machine 700 may act as a peer machine in peer-to-peer (P2P) (or other distributed) network environment. The machine 700 may be a wearable device, a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner In an example, circuits may be arranged (e.g., internally or with respect to external entities such as other circuits) in a specified manner as a module. In an example, at least a part of one or more computer systems (e.g., a standalone, client or server computer system) or one or more hardware processors 702 may be configured by firmware or software (e.g., instructions, an application portion, or an application) as a module that operates to perform specified operations. In an example, the software may reside on at least one machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform at least part of any operation described herein. Considering examples in which modules are temporarily configured, a module need not be instantiated at any one moment in time. For example, where the modules comprise a general-purpose hardware processor 702 configured using software; the general-purpose hardware processor may be configured as respective different modules at different times. Software may accordingly configure a hardware processor, for example, to constitute a particular module at one instance of time and to constitute a different module at a different instance of time. The term “application,” or variants thereof, is used expansively herein to include routines, program modules, programs, components, and the like, and may be implemented on various system configurations, including single-processor or multiprocessor systems, microprocessor-based electronics, single-core or multi-core systems, combinations thereof, and the like. Thus, the term application may be used to refer to an embodiment of software or to hardware arranged to perform at least part of any operation described herein.

Machine (e.g., computer system) 700 may include a hardware processor 702 (e.g., a central processing unit (CPU), a graphics processing unit (GPU), a hardware processor core, or any combination thereof), a main memory 704 and a static memory 706, at least some of which may communicate with others via an interlink (e g , bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR)) connection to communicate or control one or more peripheral devices (e.g., a printer, card reader, etc.).

The storage device 716 may include at least one machine readable medium 722 on which is stored one or more sets of data structures or instructions 724 (e.g., software) embodying or utilized by any one or more of the techniques or functions described herein. The instructions 724 may also reside, at least partially, additional machine readable memories such as main memory 704, static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) that configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks ((e.g., channel access methods including Code Division Multiple Access (CDMA), Time-division multiple access (TDMA), Frequency-division multiple access (FDMA), and Orthogonal Frequency Division Multiple Access (OFDMA) and cellular networks such as Global System for Mobile Communications (GSM), Universal Mobile Telecommunications System (UMTS), CDMA 2000 1x* standards and Long Term Evolution (LTE)), Plain Old Telephone (POTS) networks, and wireless data networks (e.g., Institute of Electrical and Electronics Engineers (IEEE) 802 family of standards including IEEE 802.11 standards (WiFi), IEEE 802.16 standards (WiMax®) and others), peer-to-peer (P2P) networks, or other protocols now known or later developed.

For example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

### Additional Notes & Examples

Example 1 includes subject matter (such as a device, apparatus, or machine) comprising a system to provide a user interface based on wearable device interaction, comprising: a wearable device interface to receive user interaction data from a user; a processor coupled to the interface, the processor to identify a user interaction from the user interaction data, to identify a context corresponding to the user interaction, and to initiate an action based on the identified user interaction and the identified context.

In Example 2, the subject matter of Example 1 may optionally include, wherein the context includes at least one of personal location data of a wearable device user wearing the wearable device, user profile data of the wearable device user, an emotional state of the wearable device user, a concentration level of the wearable device user, a stress level of the wearable device user, access privileges for the user to the wearable device, identification of active regions of the wearable device interface, observations of the device by the wearable device, or identified common interests between the wearable device user and the user.

In Example 3, the subject matter of any of Examples 1-2 may optionally include, wherein the context includes a proximity event corresponding to a received communication signal, wherein the processor is to identify a device corresponding to the proximity event, determine an intent of the user interaction based on the device and the context, and select the action from a plurality of actions based on the determined intent of the user interaction, the plurality of actions corresponding to the user interaction.

In Example 4, the subject matter of Example 3 may optionally include, wherein the proximity event includes the user interaction being within at least one of a temporal proximity to the received communication or a spatial proximity to the wearable device.

In Example 5, the subject matter of Example 4 may optionally include, wherein the user interaction is at least one of a touch, a movement of the device, or an orientation of the device.

In Example 6, the subject matter of any of Examples 3-5 may optionally include, wherein the user interaction is a touch, wherein the context includes an area of the wearable device interface corresponding to the touch, and wherein the intent is determined based on the area.

In Example 7, the subject matter of any of Examples 3-6 may optionally include, wherein the action includes transmitting information to the device.

In Example 8, the subject matter of Example 7 may optionally include, wherein the information includes the context.

In Example 9, the subject matter of any of Examples 3-8 may optionally include, wherein the processor is to retrieve a partner context for the device from a database, the partner context including at least one of a spatial location of the device, an orientation of the device, a user profile of the user, a trust level between the wearable device user and the device, or available interaction interfaces of the device.

In Example 10, the subject matter of Example 9 may optionally include, wherein the action is also based on the partner context.

In Example 11, the subject matter of any of Examples 3-10 may optionally include, wherein the context includes an authentication requirement for the device, the authentication requirement including touch input through the wearable device interface.

In Example 12, the subject matter of any of Examples 1-11 may optionally include, wherein the user interaction includes a gesture, wherein the context includes an orientation of the wearable device interface in space, and wherein the action corresponds to the combination of the gesture and the orientation.

Example 13 includes subject matter for a user interface based on wearable device interaction (such as a method, means for performing acts, machine readable medium including instructions that when performed by a machine cause the machine to performs acts, or an apparatus configured to perform) comprising: receiving a user interaction data from a user at a wearable device interface; identifying a user interaction from the user interaction data; identifying a context corresponding to the user interaction; and initiating an action based on the user interaction and the context.

In Example 14, the subject matter of Example 13 may optionally include, wherein the context includes at least one of personal location data of a wearable device user wearing the wearable device, user profile data of the wearable device user, an emotional state of the wearable device user, a concentration level of the wearable device user, a stress level of the wearable device user, access privileges for the user to the wearable device, identification of active regions of the wearable device interface, observations of the device by the wearable device, or identified common interests between the wearable device user and the user.

In Example 15, the subject matter of any of Examples 13-14 may optionally include, identifying a device corresponding to a proximity event, the proximity event included in the context and corresponding to a received communication signal; determining an intent of the user interaction based on the device and the context; and selecting the action from a plurality of actions based on the determined intent of the user interaction, the plurality of actions correspond to the user interaction.

In Example 16, the subject matter of Example 15 may optionally include, wherein the proximity event includes the user interaction being within at least one of a temporal proximity to the received communication or a spatial proximity to the wearable device.

In Example 17, the subject matter of Example 16 may optionally include, wherein the user interaction is at least one of a touch, a movement of the device, or an orientation of the device.

In Example 18, the subject matter of any of Examples 15-17 may optionally include, wherein the user interaction is a touch, wherein the context includes an area of the wearable device interface corresponding to the touch, and wherein the intent is determined based on the area.

In Example 19, the subject matter of any of Examples 15-18 may optionally include, wherein the action includes transmitting information to the device.

In Example 20, the subject matter of Example 19 may optionally include, wherein the information includes the context.

In Example 21, the subject matter of any of Examples 15-20 may optionally include, comprising retrieving a partner context for the device from a database, the partner context including at least one of a spatial location of the device, an orientation of the device, a user profile of the user, a trust level between the wearable device user and the device, or available interaction interfaces of the device.

In Example 22, the subject matter of Example 21 may optionally include, wherein the action is also based on the partner context.

In Example 23, the subject matter of any of Examples 15-22 may optionally include, wherein the context includes an authentication requirement for the device, the authentication requirement including touch input through the wearable device interface.

In Example 24, the subject matter of any of Examples 13-23 may optionally include, wherein the user interaction includes a gesture, wherein the context includes an orientation of the wearable device interface in space, and wherein the action corresponds to the combination of the gesture and the orientation.

Example 25 includes a machine readable medium including instructions that, when executed by a machine, cause the machine to perform any one of the Examples 13-24.

Example 26 includes an apparatus comprising means for performing any one of the Examples 13-24.

Example 27 includes an apparatus comprising: means for receiving a user interaction data from a user at a wearable device interface; means for identifying a user interaction from the user interaction data; means for identifying a context corresponding to the user interaction; and means for initiating an action based on the user interaction and the context.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1-25. (canceled)

26. A machine readable medium including instructions for a user interface based on wearable device interaction that, when executed by a machine, cause the machine to:
receive a user interaction data from a user at a wearable device interface;
identify a user interaction from the user interaction data;
identify a context corresponding to the user interaction; and
initiate an action based on the user interaction and the context.

27. The machine readable medium of claim 26, wherein the context includes at least one of personal location data of a wearable device user wearing the wearable device, user profile data of the wearable device user, an emotional state of the wearable device user, a concentration level of the wearable device user, a stress level of the wearable device user, access privileges for the user to the wearable device, identification of active regions of the wearable device interface, observations of the device by the wearable device, or identified common interests between the wearable device user and the user.

28. The machine readable medium of claim 26, comprising instructions to:
identify a device corresponding to a proximity event, the proximity event included in the context and corresponding to a received communication signal;
determine an intent of the user interaction based on the device and the context; and
select the action from a plurality of actions based on the determined intent of the user interaction, the plurality of actions correspond to the user interaction.

29. The machine readable medium of claim 28, wherein the proximity event includes the user interaction being within at least one of a temporal proximity to the received communication or a spatial proximity to the wearable device.

30. The machine readable medium of claim 29, wherein the user interaction is at least one of a touch, a movement of the device, or an orientation of the device.

31. The machine readable medium of claim 28, wherein the user interaction is a touch, wherein the context includes an area of the wearable device interface corresponding to the touch, and wherein the intent is determined based on the area.

32. The machine readable medium of claim 28, wherein the action includes transmitting information to the device.

33. The machine readable medium of claim 32, wherein the information includes the context.

34. The machine readable medium of claim 28, comprising instructions to retrieve a partner context for the device from a database, the partner context including at least one of a spatial location of the device, an orientation of the device, a user profile of the user, a trust level between the wearable device user and the device, or available interaction interfaces of the device.

35. The machine readable medium of claim 34, wherein the action is also based on the partner context.

36. The machine readable medium of claim 28, wherein the context includes an authentication requirement for the device, the authentication requirement including touch input through the wearable device interface.

37. The machine readable medium of claim 36, wherein the user interaction includes a gesture, wherein the context includes an orientation of the wearable device interface in space, and wherein the action corresponds to the combination of the gesture and the orientation.

38. A system for a user interface based on wearable device interaction, the wearable device comprising:
a wearable device interface to receive user interaction data from a user;
a processor coupled to the interface, the processor to identify a user interaction from the user interaction data, to identify a context corresponding to the user interaction, and to initiate an action based on the identified user interaction and the identified context.

39. The wearable device of claim 38, wherein the context includes at least one of personal location data of a wearable device user wearing the wearable device, user profile data of the wearable device user, an emotional state of the wearable device user, a concentration level of the wearable device user, a stress level of the wearable device user, access privileges for the user to the wearable device, identification of active regions of the wearable device interface, observations of the device by the wearable device, or identified common interests between the wearable device user and the user.

40. The wearable device of claim 38, wherein the context includes a proximity event corresponding to a received communication signal, wherein the processor is to identify a device corresponding to the proximity event, determine an intent of the user interaction based on the device and the context, and select the action from a plurality of actions based on the determined intent of the user interaction, the plurality of actions corresponding to the user interaction.

41. The wearable device of claim 40, wherein the proximity event includes the user interaction being within at least one of a temporal proximity to the received communication or a spatial proximity to the wearable device.

42. The wearable device of claim 41, wherein the user interaction is at least one of a touch, a movement of the device, or an orientation of the device.

43. The wearable device of claim 40, wherein the user interaction is a touch, wherein the context includes an area of the wearable device interface corresponding to the touch, and wherein the intent is determined based on the area.

44. A method for a user interface based on wearable device interaction, the method comprising:
receiving a user interaction data from a user at a wearable device interface;
identifying a user interaction from the user interaction data;
identifying a context corresponding to the user interaction; and
initiating an action based on the user interaction and the context.

45. The method of claim 44, wherein the context includes at least one of personal location data of a wearable device user wearing the wearable device, user profile data of the wearable device user, an emotional state of the wearable device user, a concentration level of the wearable device user, a stress level of the wearable device user, access privileges for the user to the wearable device, identification of active regions of the wearable device interface, observations of the device by the wearable device, or identified common interests between the wearable device user and the user.
